(19) United States
(12) Patent Application Publication
(10) Pub. No.: US 2009/0193886 A1
(43) Pub. Date: Aug. 6, 2009

(54) Water Usage and Temperature Monitoring Device

(76) Inventor: Gene Walkin, Miami, FL (US)

Correspondence Address: WOOD AND EISENBERG, PLLC, 6911 RICHMOND HIGHWAY, SUITE 403, Alexandria, VA, 22306, US

(21) Appl. No.: 12/025,052

(22) Filed: Feb. 4, 2008

(51) Int. Cl. G01F 1/05; G01K 13/02

(52) U.S. Cl. 73/198; 73/861.79; 374/142

(57) ABSTRACT

A water and temperature monitoring device for measuring and indicating fluid temperature and fluid flow rate includes a body connected between a fluid inlet and fluid outlet, the body having an interior; and a faceplate on the body. A temperature indicator is supported on the faceplate, and a fluid flowmeter is in contact with the fluid in the interior of the body. A fluid flow rate indicator is also supported on the faceplate, the fluid flow rate indicator being responsive to the fluid flow rate indicated by the fluid flowmeter. A temperature sensor is connected to the temperature indicator.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates generally to water and temperature monitoring devices connected to a water outlet such as a domestic shower fixture or faucet.

### BACKGROUND OF THE INVENTION

It is known in the fluid supply arts to employ various kinds of sensing, monitoring, and display of physical properties of a fluid. Such arts include water supplies for domestic usage, such as for showers and water faucets.

Given the cost of energy, it is desirable to provide a device for water usage and temperature monitoring so that a user will be able to determine energy costs while using a shower or faucet. Devices for domestic showers are known having varying degress of complexity and cost of manufacture, and varying degrees of difficulty of installation.

It is accordingly a problem in the prior art to provide a water and temperature monitoring device connected to a water outlet such as a domestic shower fixture or faucet, and which is relatively inexpensive and relatively easy to use and install.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a water and temperature monitoring device connected to a water outlet such as a domestic shower fixture or faucet. Further, the device is relatively inexpensive and relatively easy to use and install.

The device according to the present invention includes a water and temperature monitoring device having a hot and cold water mixing chamber, a water usage gallon indicator, a tenths of gallons indicator, and a temperature indicator.

Other objects and advantages of the present invention will be more readily apparent from the following detailed description when read in conjunction with the accompanying drawings.

### BRIEF DESCRIPTION OF THE DRAWINGS

FIG. 1 is schematic view of a water and temperature monitoring device according to the present invention, connected between a shower head and a water faucet.

FIG. 2 is a schematic view of valves and water flow in the water and temperature monitoring device of FIG. 1.

FIG. 3 is a front elevational view of the faceplate of the water and temperature monitoring device of FIGS. 1 and 2.

FIG. 4 is a schematic perspective view of the water and temperature monitoring device of FIGS. 1 and 2.

FIG. 5 is schematic view of the interior water flow through the water and temperature monitoring device of FIGS. 1 and 2.

FIG. 6 is a schematic side elevational view of an impeller usable in the water and temperature monitoring device of FIGS. 1 and 2.

FIG. 7 is an end elevational view of the impeller of FIG. 6.

FIG. 8 is a schematic side view of an alternative water flow sensing device using measurement of pressure drop past an orifice in a water line, usable with the device of FIG. 1.

FIG. 9 is a schematic view of an embodiment of a gear mechanism connectable with the impeller of FIGS. 6 and 7, for converting rotational motion of the impeller to an output indicating water flow in gallons and tenths of gallons.

FIG. 10 is a prior art diagram indicating an electronic prior art temperature and flow sensor having a control CPU, a digital temperature sensor, a memory, and a mixing valve.

### DETAILED DESCRIPTION OF THE INVENTION

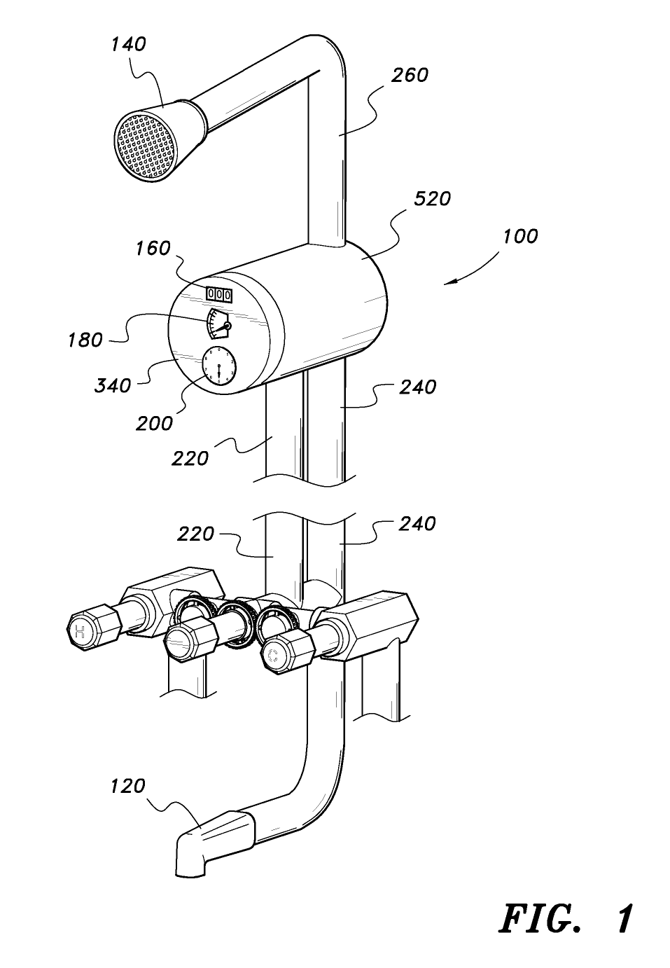

FIG. 1 is schematic view of a water and temperature monitoring device 100 connected between a shower head 140 and a water faucet 120. The water and temperature monitoring device 100 has a generally cylindrical body 520 and a faceplate 340. The faceplate 340 carries a display which includes a gallon indicator 160, a temperature gauge 180, and a tenths of a gallon indicator 200.

A pair of water conduits 220 and 240 connect the cylindrical body 520 of the water and temperature monitoring device 100 to the water faucet 120. A water conduit 260 connects the cylindrical body 520 of the water and temperature monitoring device 100 to the shower head 140.

The temperature gauge 180 is shown as a pivotable arm which can be mechanically actuated in a manner known to anyone having skill in the temperature measuring and indicating arts, or can be a electronically or electrically actuated in a manner known to anyone having skill in the electrical and electronic temperature measuring and indicating arts.

The gallon indicator 160 is a numeric readout of the measured flow rate of water being used, indicated in gallons. This can be mechanically actuated in a manner known to anyone having skill in the fluid flow measuring and indicating arts, or can be a electronically or electrically actuated in a manner known to anyone having skill in the electrical and electronic fluid flow measuring and indicating arts.

The tenths of a gallon indicator 200 is a numeric readout of the measured flow rate of water being used, indicated in tenths of a gallon. This can be mechanically actuated in a manner known to anyone having skill in the fluid flow measuring and indicating arts, or can be a electronically or electrically actuated in a manner known to anyone having skill in the electrical and electronic fluid flow measuring and indicating arts.

As shown in FIG. 1, the cylindrical body 520 of the water and temperature monitoring device 100 is easily installable as a unit in an existing shower unit, and is readily connected to the conduits 220, 240, and 260.

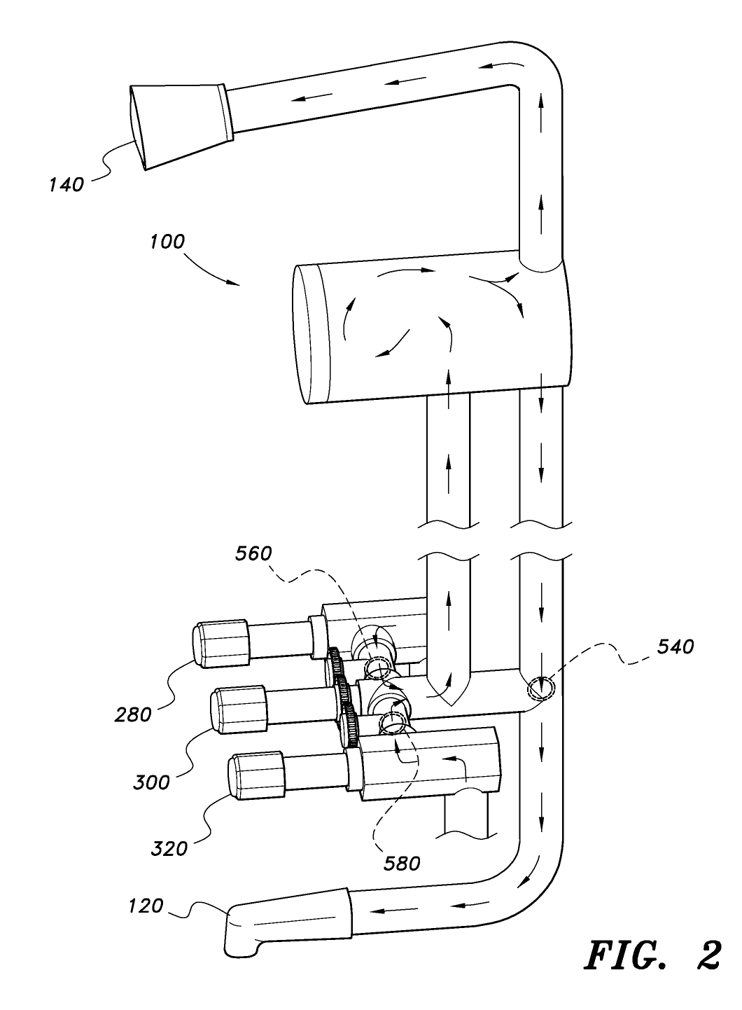

FIG. 2 is a schematic view of valves and water flow in the water and temperature monitoring device 100 of FIG. 1. In this view, water flow is indicated schematically by arrows. The water and temperature monitoring device 100 includes a hot water valve 280, an UP/OFF/DOWN valve 300, and a cold water valve 320. An open and close valve 560 is disposed between the hot water valve 280 and the UP/OFF/DOWN valve 300. An open and close valve 580 is disposed between the UP/OFF/DOWN valve 300 and the cold water valve 320. Additionally, a tub and shower valve 540 is shown for directing water selectively between the shower head 140 and the water faucet 120. The tub and shower valve 540 of FIG. 2 is actuated by the UP/OFF/DOWN valve 300.

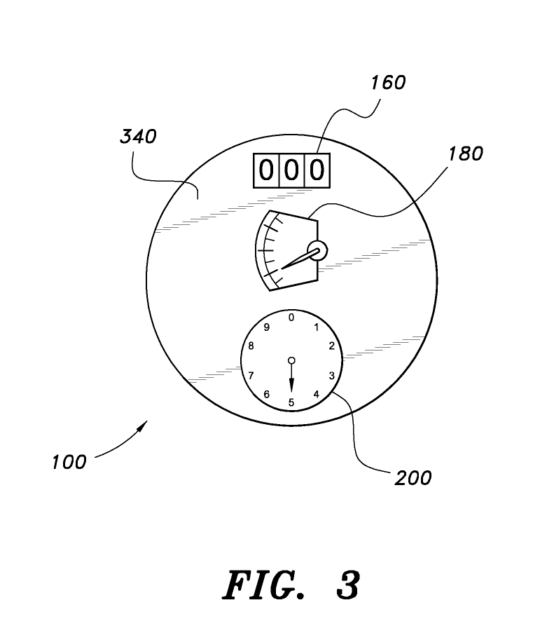

FIG. 3 is a front elevational view of the faceplate 340 of the water and temperature monitoring device 100 of FIGS. 1 and 2.

The faceplate 340 shows an embodiment of the gallon indicator 160, the temperature gauge 180, and the tenths of a gallon indicator 200. The tenths of a gallon indicator 200 is preferably a dial indicator having an arm rotating about an axis, so that a user can quickly judge the water flow rate by the spinning rate of the dial of the tenths of a gallon indicator 200.

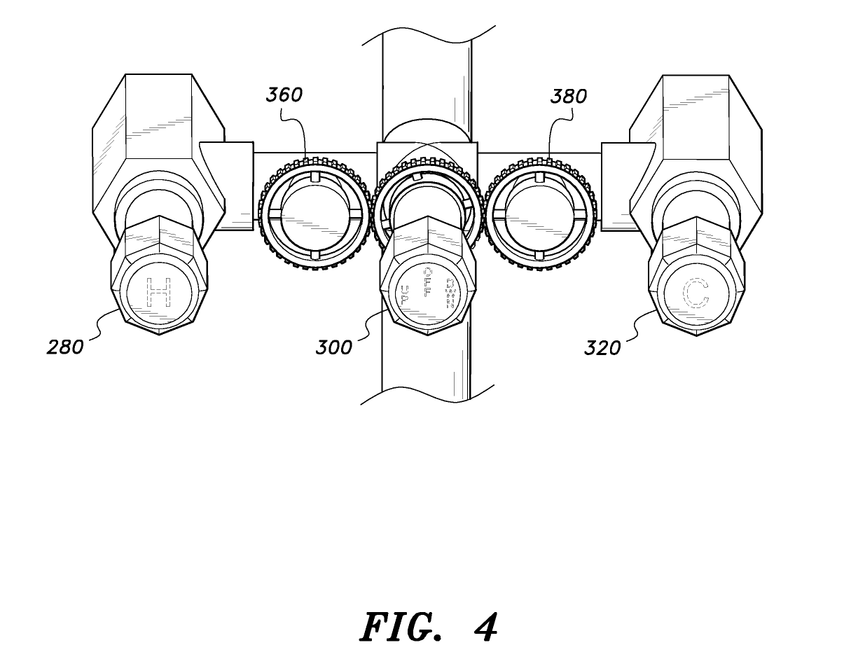

FIG. 4 is a schematic perspective view of the valves usable with the water and temperature monitoring device 100 of FIGS. 1 and 2. The valves include the hot water valve 280, the UP/OFF/DOWN valve 300, the cold water valve 320, a valve 360 connected to operate the open and close valve 560, and a valve 380 connected to operate the open and close valve 580. Other valve and control arrangements may also be used, and all such variations are contemplated as being within the scope of the present invention.

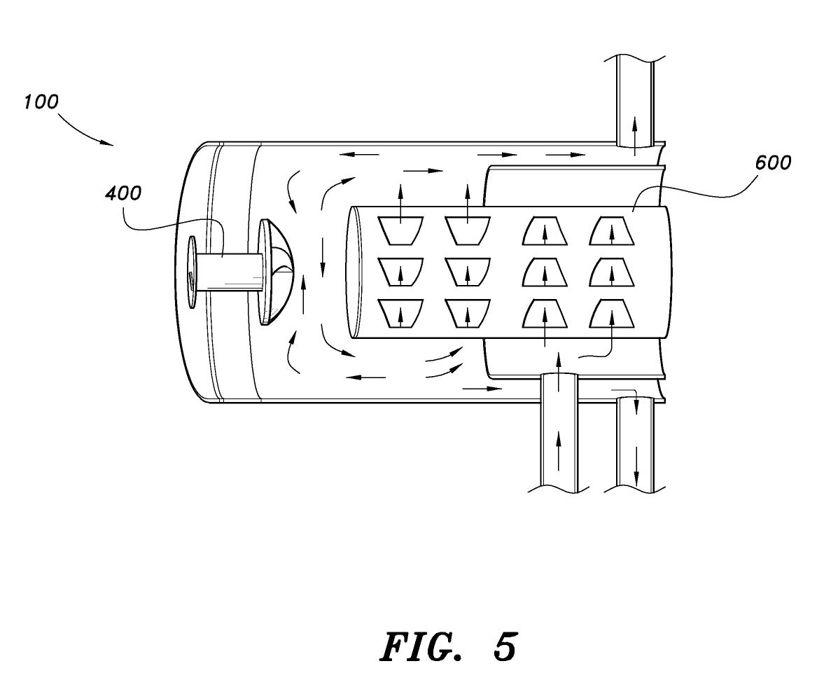

FIG. 5 is schematic view of the interior water flow through the water and temperature monitoring device 100 of FIGS. 1 and 2. The water flow is indicated by arrows in FIG. 5, and shows a schematic interior of the water and temperature monitoring device 100 showing mixing of the hot and cold water taking place, with water going into the water and temperature monitoring device 100, and water coming out of the water and temperature monitoring device 100 and going to a shower and to a bath tub. As shown in FIG. 5, a perforated interior cylinder 600 enables mixing and water flow control. An impeller 400 is schematically shown in FIG. 5, and has an end which is rotated by water flow through the water and temperature monitoring device 100.

A temperature sensing element (not shown in FIG. 5) is preferably disposed in the interior of the cylindrical body 520 and connected to the temperature gauge 180. If the temperature sensing element is a bimetallic strip, it can be connected directly behind the temperature gauge 180.

If the temperature sensing element is a thermistor or other electronic temperature sensing element, it can be disposed anywhere inside the cylindrical body 520 or even on the impeller 400 itself. In this case, the temperature gauge 180 can be connected by a wire or by a wireless communication device to the temperature sensing element inside the cylindrical body 520.

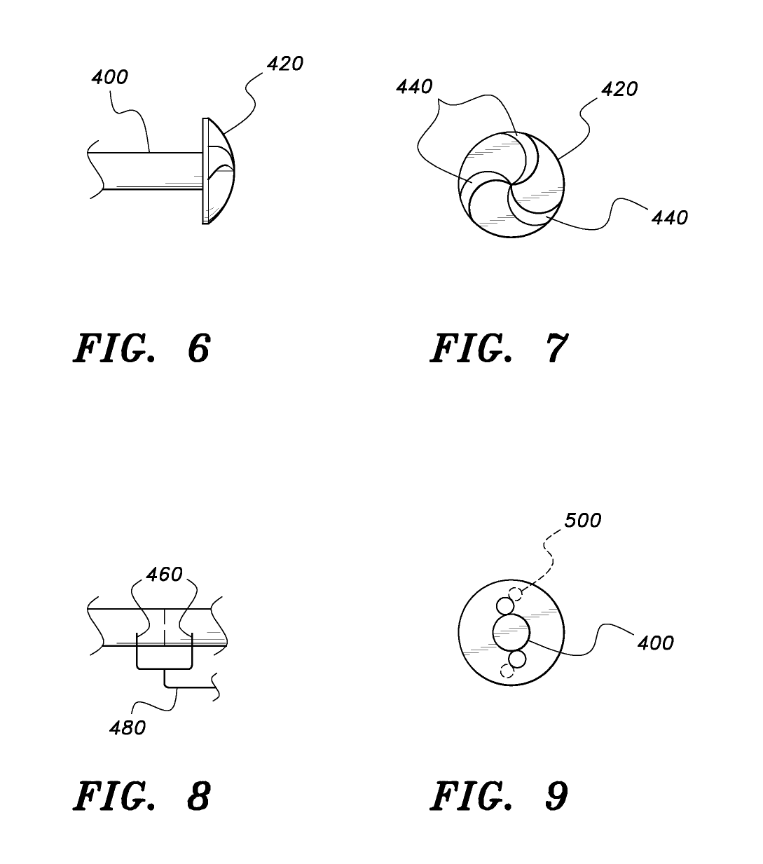

FIG. 6 is a schematic side elevational view of one embodiment of an impeller 400 usable in the water and temperature monitoring device 100 of FIGS. 1 and 2. Here, the impeller 400 has a head 420 which is actuated by water flow.

FIG. 7 is an end elevational view of the impeller head 420 of the impeller 400 of FIG. 6. In this view, spiral grooves 440, 440, and 440 are shown to enhance fluidic engagement of the impeller head 420 with the flowing water.

Other types of water flow impellers are known, and can be used in the present invention. An example of such an impeller is that shown in FIG. 1 of U.S. Pat. No. 4,057,173, the entire disclosure of which is incorporated herein in its entirety by reference thereto. All such variations of flow measuring devices having impellers are contemplated as being within the scope of the present invention.

FIG. 8 is a schematic side view of an alternative water flow sensing device using measurement of pressure drop past an orifice in a water line. This alternative device has a pair of pressure sensors 460, 460 connected to measure a differential pressure flowing in a conduit across a restrictor plate or orifice plate (shown schematically in FIG. 8). The differential pressure is sensed either as a pressure output 480, or alternatively as a digital output 480.

FIG. 9 is a schematic view of an embodiment of a gear mechanism 500 connectable with the impeller 400 of FIGS. 6 and 7, for converting rotational motion of the impeller 400 to an output indicating water flow in gallons and tenths of gallons. The gear mechanism shown is merely schematic, and many types of gear arrangements could be used; such gear arrangements are old and well known in the indicating arts prior to the advent of digital electronics.

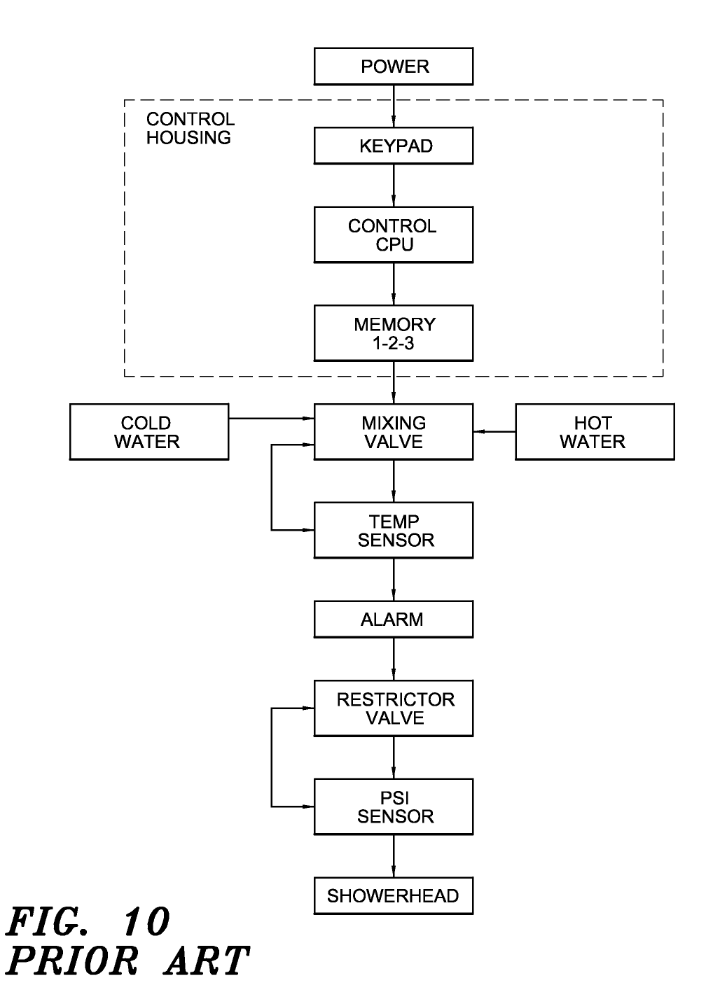

FIG. 10 is a prior art diagram indicating an electronic prior art temperature and flow sensor having a control CPU, a digital temperature sensor, a memory, and a mixing valve. This shows that digital measurements can be used along with digital displays. This prior art diagram is found in U.S. Pat. No. 6,250,558, the entire disclosure of which is incorporated herein in its entirety by reference thereto. All such variations of electronic elements for flow measuring devices having impellers are contemplated as being within the scope of the present invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

1. A water and temperature monitoring device for measuring and indicating fluid temperature and fluid flow rate, comprising:
a body connected between a fluid inlet and fluid outlet, said body having an interior;
a faceplate on said body;
a temperature indicator being supported on said faceplate;
a fluid flowmeter being in contact with the fluid in the interior of said body, wherein said fluid flowmeter is an impeller, said impeller having a head having a plurality of spiral grooves thereon;
a fluid flow rate indicator supported on said faceplate, said fluid flow rate indicator being responsive to the fluid flow rate indicated by said fluid flowmeter; and
a temperature sensor connected to said temperature indicator, said temperature sensor being disposed in thermal contact with fluid flowing in the interior of said body.

2. A water and temperature monitoring device as claimed in claim 1, wherein the temperature sensor is a bimetallic strip.

3. A water and temperature monitoring device as claimed in claim 1, wherein the temperature sensor is a thermistor.

4-5. (canceled)

6. A water and temperature monitoring device as claimed in claim 1, wherein the fluid flow rate indicator includes a readout measured in gallons.

7. A water and temperature monitoring device as claimed in claim 1, wherein the fluid flow rate indicator includes a readout measured in gallons, and a second readout measured in tenths of gallons.

8. A water and temperature monitoring device as claimed in claim 1, wherein the fluid flow rate indicator includes a readout measured in gallons, and a second readout having a rotary dial indicator for measuring flow in tenths of gallons.
